(19) United States
(12) Patent Application Publication
(10) Pub. No.: US 2008/0245769 A1
(43) Pub. Date: Oct. 9, 2008

(54) Nanoparticles and method of making thereof

(75) Inventor: Partha S. Dutta, Clifton Park, NY (US)

Correspondence Address: FOLEY AND LARDNER LLP;SUITE 500, 3000 K STREET NW, WASHINGTON, DC, 20007, US

(73) Assignee: Applied NanoWorks, Inc.

(21) Appl. No.: 11/826,565

(22) Filed: Jul. 17, 2007

Related U.S. Application Data
(60) Provisional application No. 60/831,205, filed on Jul. 17, 2006.

(51) Int. Cl. C23F 1/00; B05D 5/00

(52) U.S. Cl. 216/53; 427/180; 216/96; 216/100; 216/102; 216/105

(57) ABSTRACT

A method of making nanoparticles includes reacting a first material powder with a second material vapor to form a surface coating on particles of the first material powder, and selectively removing the first material powder to convert the surface coating to third material nanoparticles.

### CROSS REFERENCE TO RELATED APPLICATIONS

This application claims benefit of provisional Application No. 60/831,205, filed Jul. 17, 2006, the contents of which are incorporated herein in their entirety.

### FIELD OF THE INVENTION

The present invention is directed generally to compositions of matter and more particularly to nanoparticles and methods of making thereof.

### BACKGROUND OF THE INVENTION

In principle, nanoparticles of any material can be generated by thoroughly grinding a bulk solid of the given material, by a grinding process such as ball milling, as discussed, for example, in “Large-scale synthesis of ultrafine Si nanoparticles by ball milling” C. Lam, Y. F. Zhang, Y. H. Tang, C. S. Lee, I. Bello, S. T. Lee, Journal of Crystal Growth 220 (2000) 466-470. However as simple as it may appear, grinding does not lead to uniform particle sizes due to aggregation of the particles after they have been crushed and powdered to sub-micron chunks. To get nanoparticles below 100 nm, it may take up to several days of grinding, making the grinding process, such as a ball milling process, unsuitable for large scale production. When nanoparticles are produced by ball milling for a prolonged period of time, such as for several days, the nanoparticles are frequently contaminated and undesirable impurities of foreign materials have been detected in such nanoparticle samples. Thus, many commercial nanoparticle synthesis methods use high temperature processes, including formation of nanoparticles by reaction from chemicals or physical disintegration of big particles by pyrolysis. However, these methods are often complex, expensive, difficult to control due to the high process temperature and often use environmentally harmful and dangerous chemicals.

A relatively new correlative method for easier manipulation and spatial organization of the nanoparticles has been proposed in which the nanoparticles are encapsulated in a shell. The shells which encapsulate the nanoparticles are composed of various organic materials such as Polyvinyl Alcohol (PVA), PMMA, and PPV. Furthermore, semiconductor shells have also been suggested.

For example, U.S. Pat. Nos. 6,225,198 and 5,505,928, incorporated herein by reference, disclose a method of forming nanoparticles using an organic surfactant. The process described in the U.S. Pat. No. 6,225,198 patent includes providing organic compounds, which are precursors of Group II and Group VI elements, in an organic solvent. A hot organic surfactant mixture is added to the precursor solution. The addition of the hot organic surfactant mixture causes precipitation of the II-VI semiconductor nanoparticles. The surfactants coat the nanoparticles to control the size of the nanoparticles. However, this method is disadvantageous because it involves the use of a high temperature (above 200° C.) process and toxic reactants and surfactants. The resulting nanoparticles are coated with a layer of an organic surfactant and some surfactant is incorporated into the semiconductor nanoparticles. The organic surfactant negatively affects the optical and electrical properties of the nanoparticles.

In another prior art method, II-VI semiconductor nanoparticles were encapsulated in a shell comprising a different II-VI semiconductor material, as described in U.S. Pat. No. 6,207,229, incorporated herein by reference. However, the shell also interferes with the optical and electrical properties of the nanoparticles, decreasing quantum efficiency of the radiation and the production yield of the nanoparticles.

### SUMMARY

An embodiment of the invention provides method of making nanoparticles comprising reacting a first material powder with a second material vapor to form a surface coating on particles of the first material powder, and selectively removing the first material powder to convert the surface coating to third material nanoparticles.

### DESCRIPTION OF THE DRAWINGS

FIG. 1 is a side cross sectional schematic view of an apparatus according to an embodiment of the invention.

FIGS. 2 and 3 are side cross sectional schematic views of steps in a method according to an embodiment of the invention.

FIGS. 4, 5 and 6 are plots of particle size distributions of nanoparticles of the examples of the invention.

FIGS. 7, 8, 9, 10 and 11 are plots of photoluminescence emission spectra recorded with different excitation wavelengths for nanoparticles of the examples of the invention.

### DETAILED DESCRIPTION OF THE PREFERRED EMBODIMENTS

The present inventor has realized that nanoparticles may be formed by a simple process which includes reacting a first material powder with a second material vapor to form a surface coating on particles of the first material powder, and selectively removing the first material powder to convert the surface coating to third material nanoparticles.

The term nanoparticles includes particles having an average size between about 2 and about 100 nm, preferably particles having an average size between about 5 and about 20 nm, such as about 15 nm.

The nanoparticles may comprise luminescent semiconductor nanoparticles having an average size that is smaller than about four times of the Exciton Bohr Radius for the particular nanoparticle composition. The Exciton Bohr Radius varies for different semiconductor materials. For example, this Radius ranges from about 3-4 nm for ZnSe to about 5-6 nm for CdSe and CdTe to over 40 nm for PbSe.

In one aspect of the invention, the average nanoparticle size (i.e., diameter) is larger than a diameter at which the nanoparticle becomes a true quantum dot. In other words, the nanoparticle diameter is large enough that the intermediate confinement regime rather than the strong confinement regime predominates and the energy levels of the nanoparticles may be considered continuous rather than discrete. In such nanoparticles, the band gap height comprises a fixed value which is determined by the composition of the nanoparticle, as it would be in a bulk semiconductor material, rather than being variable with nanoparticle size, as would be the case in true quantum dots. Thus, the nanoparticles preferably comprise luminescent semiconductor nanoparticles whose peak luminescence wavelength is determined by a composition of the semiconductor material, rather than by activator ions or the size of the nanoparticles. Thus, the nanoparticles are preferably not doped with activator ions and have an average size at which the bulk semiconductor material band gap rather than the nanoparticle size determines the peak luminescence wavelength. Therefore, the average nanoparticle diameter is preferably ranges between about 0.9 and about 4, such as between about 1.1 and about 2 of the Exciton Bohr Radius for the material of the nanoparticle.

However, other nanoparticles, such as non-luminescent and/or non-semiconductor nanoparticles, or activator doped luminescent nanoparticles, or true quantum dots with a diameter of less than its Exciton Bohr Radius may be used.

The method of making the nanoparticles includes reacting a first material powder with a second material vapor to form a surface coating on particles of the first material powder, and selectively removing the first material powder to convert the surface coating to third material nanoparticles.

The step of reacting the first material powder with the second material vapor may include providing the first material powder and a second material powder and heating at least the second material powder to generate the second material vapor. For example, as shown in FIG. 1, the first material powder 1 is placed a first vessel 3 and the second material powder 5 is placed in a second vessel 7. The first vessel 3 and the second vessel 7 are heated to generate the second material vapor 9 from at least a portion of the second material powder 5 in the second vessel 7. The vapor 9 is then provided to the first vessel 3 where the vapor 9 reacts with the first material powder 1. For example, the first 3 and second 7 vessels may comprise sealed retorts which are connected to each other by a channel 11 through which the vapor 9 flows from the second retort 7 to the first retort 3. However, any other suitable vessels may also be used, as long as they can hold powder and have openings through which the vapor from one vessel may reach the other vessel. Alternatively, if desired, the first 1 and the second 5 powder may be placed in the same vessel adjacent to-each other, separated from each other, or in contact with each other.

The first 1 and the second 5 powders may be heated using any suitable heating method. For example, the powders may be heated by placing the vessels 3, 7 in a furnace and heating the powders to about 400 to about 1400° C., such as 600 to about 800° C. If desired, the vessels 3, 7 may be heated to different temperatures from each other in a dual zone furnace. Vessel 3 may be maintained at a higher or lower temperature than vessel 7. Alternatively, other heating methods, such as flash lamp, laser, or RF heating may be used. Furthermore, other temperatures may be used depending on the selected materials.

Any suitable materials 1, 5 may be used. As indicated above, preferably, the materials 1, 5 are in powder form. For example, the powders may comprise bulk powders having an average particle size of one micron or greater, such as between 10 and 10,000 microns. However, powders with smaller or larger particles sizes may also be used. Alternatively, non-powder bulk materials may also be used.

In one aspect of the invention, the first material powder 1 may comprise a powder containing at least one element from Groups Ib to VIIb or Groups Ia to IVa and a different second element from Groups IVa to VIIa of the Periodic Table. For example, the first material powder may comprise a metal oxide, a metal nitride or a metal sulfide powder, such as a powder selected from Zn, Cd, Pb, Al, Ga and In oxides, nitrides and sulfides (including zinc oxide, zinc sulfide, cadmium oxide, alumina, aluminum nitride, lead oxide, gallium nitride, indium oxide, etc.). More than one type of material may be used at the same time. Furthermore, a metal rather than a metal oxide or a nitride powder may also be used. The powder particles may contain more than one type of metal to form ternary and quaternary compound semiconductors.

The second material 5 preferably comprises a non-metal, such as at least one element from groups VIa or VIIa of the Periodic Table. The second material powder (or bulk material) 5 may comprise at least one of N, P, As, Sb, S, Se and Te. More than one type of material may be used at the same time to form ternary and quaternary compound semiconductors.

When the second material is heated, it forms a vapor 9. The vapor 9 may comprise a single component or a multiple component vapor. For example, the vapor may comprise a Se and Te containing vapor to form ternary II-VI nanoparticles.

When the vapor 9 reacts with the surface of the particles of the first material powder 1, a surface coating 13 forms on a surface of the particles of the first material powder, as shown in FIG. 2. Without wishing to be bound by a particular theory, it is believed that the surface coating 13 may comprise a relatively thin shell, such as a shell having a thickness less than four Exciton Bohr Radii of the shell material and/or a plurality of nanoparticles clustered on the surface of the larger particles of the first powder 1, as shown in FIG. 2. For example, the shell may comprise a 5 to 20 nm thick shell.

The first material powder 1 is then selectively removed compared to the surface coating material 13 to convert the surface coating to third material nanoparticles 15, as shown in FIG. 3. Preferably, the powder 1 is selectively etched compared to the surface coating material 13. However, other removal steps, such as mechanical removal steps, including grinding, sonification, etc. may also be used together with or instead of the etching.

Thus, if the surface coating 13 comprises nanoparticles, then the nanoparticles 15 are released when the larger first material powder particles 1 are etched away. If the surface coating 13 comprises a thin shell, then the shell is broken up into nanoparticles 15. The nanoparticles 15 may comprise any material, such as III-V, II-VI or Pb-VI compound semiconductor nanoparticles. Examples of II-VI and Pb-VI nanoparticles include CdS, ZnS, PbS, CdSe, ZnSe, PbSe, ZnTe, PbTe and CdTe nanoparticles. Ternary and quaternary semiconductor nanoparticles, such as ZnSSe, ZnSTe, ZnSeTe, CdZnS, CdZnSe, CdZnTe, ZnSSeTe, CdZnTeSe and CdZnSSe, for example, may also be used. Furthermore, semiconductor nanoparticles other than IV-VI or II-VI nanoparticles may also be used. These nanoparticles include GaAs, GaP, GaN, InP, InAs, GaAlAs, GaAlP, GaAlN, GaInN, GaAlAsP, GaAlInN, and various other III-V materials. Furthermore, non-semiconductor nanoparticles, such as oxide or nitride nanoparticles, may also be formed by this method.

If selective etching is used, then any suitable etching medium, such as an etching liquid, may be used for the selective etching. The etching liquid should selectively etch the first material particles 1 over the surface coating 13/nanoparticle 15 material. Thus, for ZnSSe surface coating 13 formed on ZnO particles 1, any etching liquid which selectively etches ZnO over ZnSSe may be used to release the ZnSSe nanoparticles 15.

The surface coating 13 material composition may be controlled by controlling the ratios of the first 1 and the second 5 materials. Thus, controlling the composition of the surface coating 13/nanoparticle 15 material controls a luminescence color of this material.

After the nanoparticles 15 are formed, they may optionally be further etched to reduce the nanoparticle size and/or to reduce a size of nanoparticle clusters. Any suitable etching medium, such as HCl for example, which can etch the nanoparticles 15 may be used. Alternatively, the nanoparticles 15 may be subjected to an optional grinding step to reduce a size of nanoparticle clusters in addition or instead of the second etching step.

The nanoparticles may be used in various fields of technology, such as nanotechnology, semiconductors, light emitting devices, electronics, biotechnology, coating, agricultural and optoelectronics, such as in abrasives (including chemical mechanical polishing powder), thermal and conductivity altering additives, UV absorbing materials, opacity additives and catalysts.

The following is an illustrative method of making the nanoparticles 15 according to an embodiment of the invention. ZnO or ZnS powder 1 is placed into one retort 3 and one or more of the S, Te, S and/or Se powders 5 is placed into another retort 7. The retorts 3, 7 are connected via a small channel 11 that allows fumes 9 from one retort 7 to pass into the other retort 3. The retorts 3, 7 are placed into a furnace heated to 600-800° C. The furnace may be pre-heated to the desired temperature before the retorts are loaded or the furnace may be ramped up to the desired temperature after the retorts are loaded. The ratios of the precursors determine the emission color (i.e., the peak emission wavelength) of the nanoparticles. The retorts are heated for a desired period, such as 1-4 hours, for example 2-3 hours. Depending on the ratios of the precursors, ZnTeS nanoparticles 15 are provided for red light emission and ZnSeS and/or ZnSeSTe nanoparticles are provided for orange through blue light emission (i.e., different Se to S ratios in the nanoparticles can provide nanoparticle emission colors from orange through blue).

Thus, by reacting a powder, such as a ZnO or ZnS powder, with high purity elements, such as S, Se, Te or a mixture of two or more elements, in a variety of ambients, such as vacuum, inert gas or oxygen at high temperature, luminescent nanoparticles are grown on the surface of the particles (such as ZnO or ZnS particles) that constitute the powder. The wavelength of the luminescence of the nanoparticles can be tuned in the entire visible range from 400-650 nm based on the nanoparticle composition. After the nanoparticle formation reaction, the resulting powders are ground using mortar and pestle to separate the nanoparticles from the surface of the bigger powder particles. This is followed by selectively chemically etching the non-luminescent powder particles. The chemical solution is chosen to be a preferential or selective etchant that would etch the powder materials at a much faster rate than the luminescent nanoparticle materials.

The following specific examples are provided for illustration only and should not be considered limiting on the scope of the claims.

### General Experimental Procedure

The size distribution of the particles (powder plus luminescent nanoparticles) suspended in water was measured using photon correlation spectroscopy (PCS). An N5 particle size analyzer (manufactured by Beckman Coulter corporation) was used for the PCS measurements. The luminescent properties of the nanoparticles were measured by a photoluminescence (PL) spectroscopic technique. The PL measurements were carried out using the CARY Eclipse, a fluorescence spectrophotometer manufactured by Varian corporation. For the PL measurements, the luminescent nanoparticles were mixed with an Epo-Tek epoxy (purchased from Epoxy Technology) and spread onto glass slides. The epoxies were cured and dried for 24 hours before the PL measurements. The excitation wavelengths used during the PL measurements were in the range of 250-450 nm.

The specific examples with experimental data relevant to the luminescent nanoparticle manufacturing process are provided below.

### EXAMPLE 1

A dual chamber quartz (silica) crucible was designed according to FIG. 1. The two chambers 3, 7 of the crucible were separated by a baffle with a hole of 1-2 mm diameter. High purity (5 N) elemental tellurium (Te) was placed in one of the chambers. ZnO powder with average particle size of 1 μm was placed in the other chamber. The crucible was placed in a two zone high temperature furnace chamber. The chamber was evacuated to 1 mTorr vacuum and then filled with argon gas to maintain an inert ambient during the reaction. The tellurium (Te) was heated to approximately 600° C. and the ZnO powder was heated to approximately 800° C. The crucible was kept at high temperature for 2 hours and then rapidly cooled to room temperature. The resulting powder (with ZnTe nanoparticles on ZnO powder particle surface) exhibited a red glow when illuminated by an ultra-violet lamp. The ZnO powder was slowly etched in a solution consisting of glacial acetic acid (CH₃COOH): water (H₂O): ammonium hydroxide NH₄OH in volume ratio of 1:100:1. During the etching, the etchant solution was replenished from time to time and magnetic stirrer was used to stir the solution.

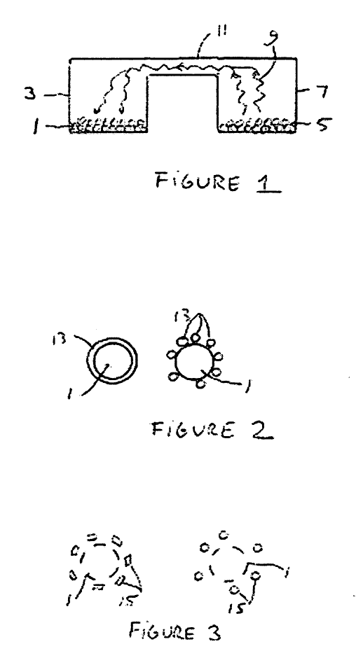

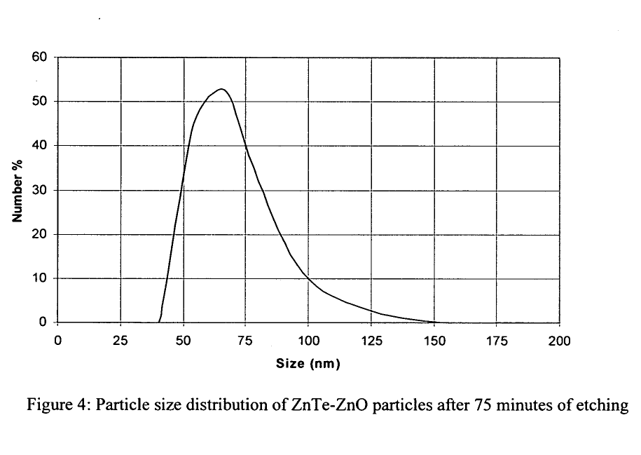

During the etching cycle, the particles were extracted, dried and re-suspended in pure water for the PCS measurements. FIGS. 4-6 show the particle size distribution as measured by PCS to illustrate the evolution of the etching process. As shown in FIG. 4, after 75 minutes of etching, the resulting particles exhibited a size distribution. It clearly shows that average particle size (i.e., diameter) has decreased from about 1 μm to about 60 nm.

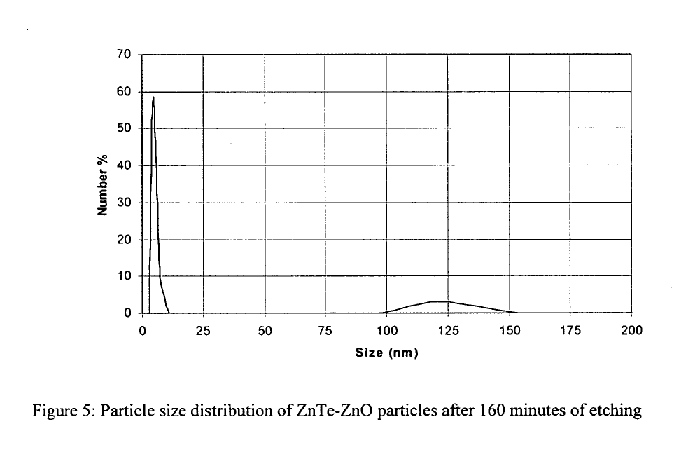

As shown in FIG. 5, after 160 minutes of etching, the particle size distribution exhibited a bi-modal distribution with some larger particles still remaining in the solution. At this time, most of the particles had an average size of less than 20 nm.

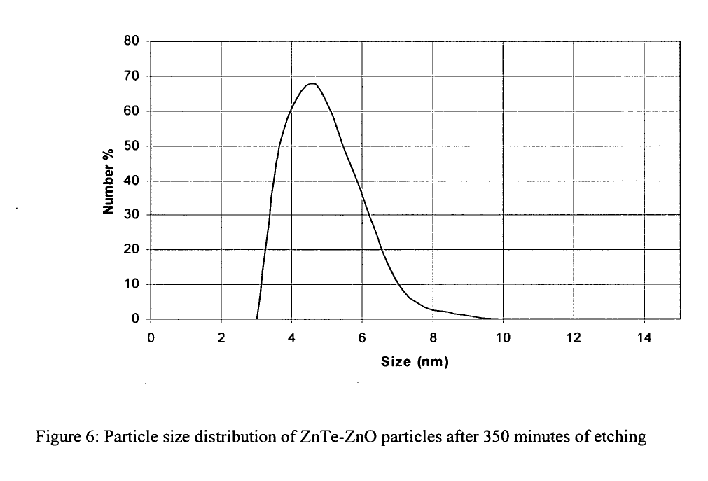

As shown in FIG. 6, after 350 minutes of etching, the bigger ZnO particles disappeared and the particle size distribution was in the range of about 3 to about 9 nm, with an average particle size of about 4.5 to 5 nm. This particle size distribution did not change with further exposure to the etching solution. The resulting nanoparticles (ZnTe) still exhibited red glow when illuminated by a UV lamp.

### EXAMPLE 2

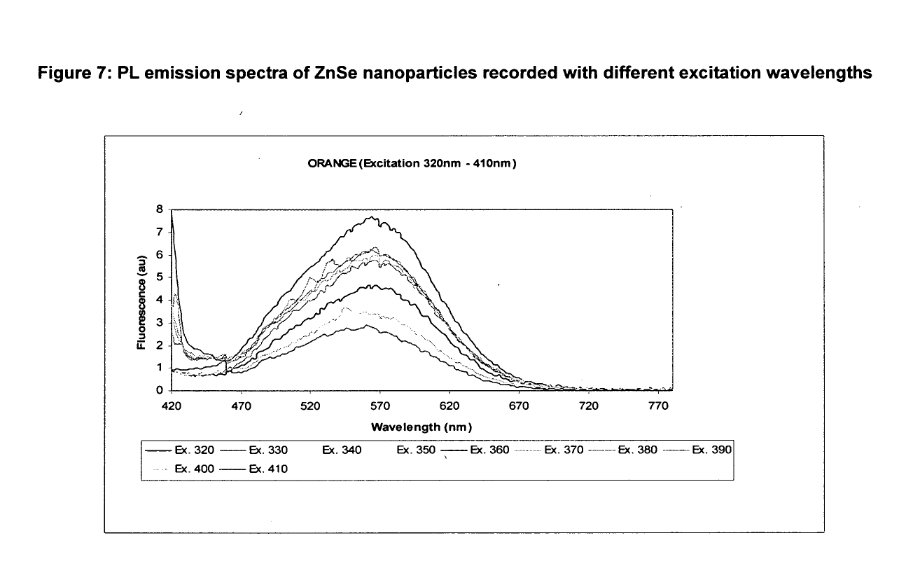

Using the same experimental configuration and reaction times as in example 1 with ZnO and Se powders in separate chambers, an orange glowing powder (when illuminated by UV lamp) believed to be a ZnSe nanoparticle powder was obtained. FIG. 7 shows PL emission spectra of the powder recorded with different excitation wavelengths ranging from 320 nm to 410 nm (and varying by 10 nm as shown in FIG. 7, where each excitation wavelength is marked “Ex”). The PL peak wavelength was around 570 nm for most excitation wavelengths. Thus, an orange emitting nanoparticle powder was obtained.

### EXAMPLE 3

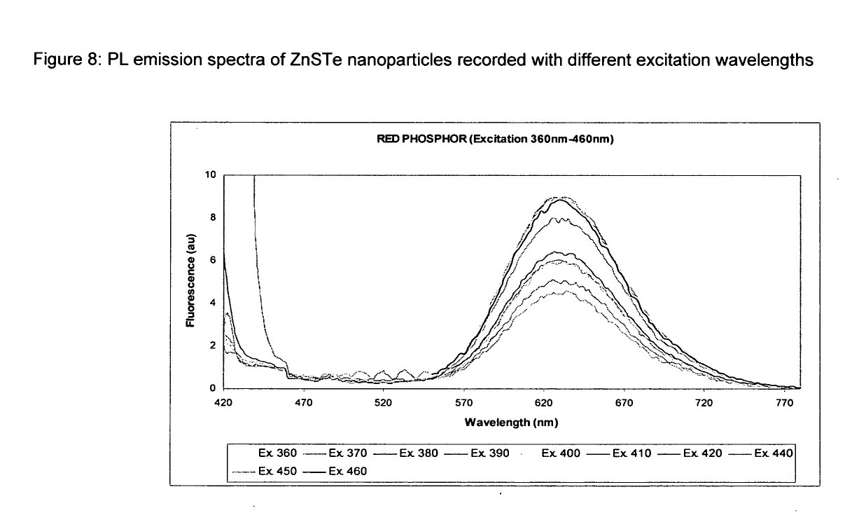

Using the same experimental configuration and reaction times as in example 1 with ZnO powder in one chamber and a mixture of S and Te powders (in equal amounts) in the other chamber, a red glowing powder (when illuminated by UV lamp) believed to be ZnSTe nanoparticle powder was obtained. FIG. 8 shows PL emission spectra of the powder recorded with different excitation wavelengths ranging from 360 nm to 460 nm (and varying by 10 nm as shown in FIG. 8). The PL peak wavelength was around 635 nm for all excitation wavelengths. Thus, a red emitting nanoparticle powder was obtained.

### EXAMPLE 4

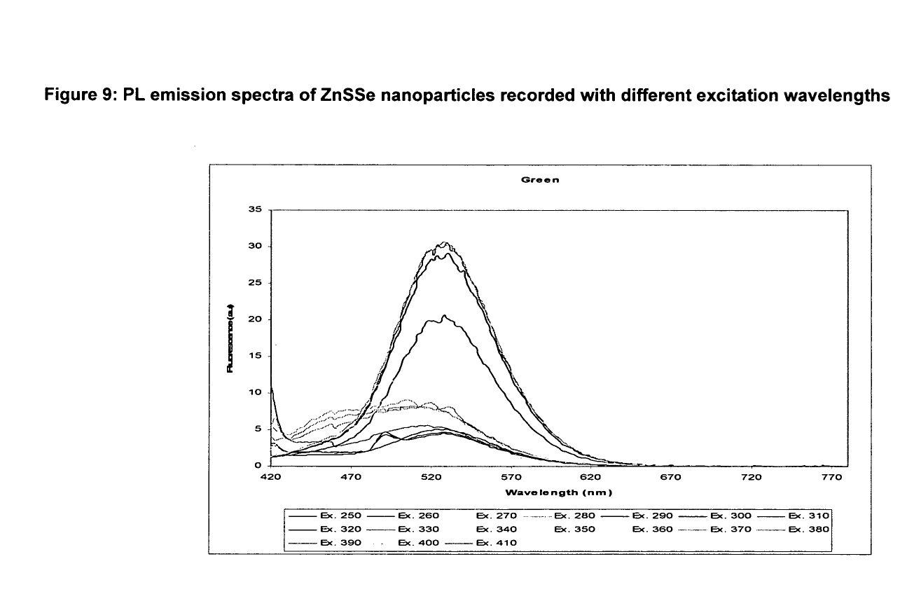

Using the same experimental configuration and reaction times as in example 1 with ZnO powder in one chamber and a mixture of S and Se powders (in equal amounts) in the other chamber, a green glowing powder (when illuminated by UV lamp) believed to be a ZnSSe nanoparticle powder was obtained. FIG. 9 shows PL emission spectra of the powder recorded with different excitation wavelengths ranging from 250 nm to 410 nm (and varying by 10 nm as shown in FIG. 9). The PL peak wavelength was around 525 nm for most excitation wavelengths. Thus, a green emitting nanoparticle powder was obtained. It should be noted that ZnTeSe, ZnSTe or ZnSSeTe green emitting nanoparticles may be used instead. In fact, ZnSSeTe nanoparticles may be used to emit other colors described herein besides green.

### EXAMPLE 5

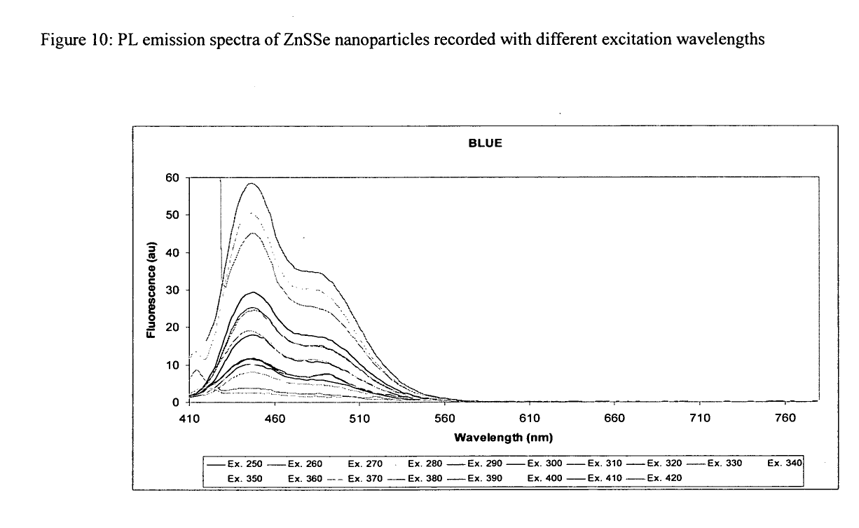

Using the same experimental configuration and reaction times as in example 1 but with oxygen ambient and reacting a ZnS powder in one chamber and a mixture of S and Se powders (in 10:1 ratio) in the other chamber, a blue glowing powder (when illuminated by UV lamp) believed to be a ZnSSe nanoparticle powder was obtained. FIG. 10 shows PL emission spectra of the powder recorded with different excitation wavelengths ranging from 250 nm to 420 nm (and varying by 10 nm as shown in FIG. 10). The wavelengths of the two PL peaks are around 440 and 500 nm. Thus, a blue emitting nanoparticle powder was obtained.

### EXAMPLE 6

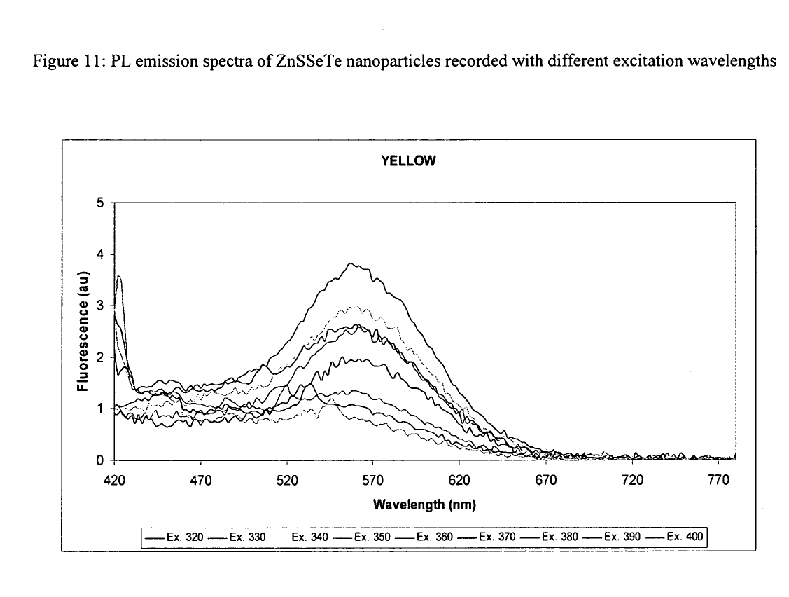

Using the same experimental configuration and reaction times as in example 1 with ZnO powder in one chamber and a mixture of S, Se and Te powders (in equal amounts) in the other chamber, a yellow glowing powder (when illuminated by UV lamp) believed to be ZnSSeTe nanoparticle powder was obtained. FIG. 11 shows PL emission spectra of the powder recorded with different excitation wavelengths ranging from 320 nm to 400 nm (and varying by 10 nm as shown in FIG. 11). The PL peak wavelength was around 560 nm for most excitation wavelengths. Thus, a yellow emitting nanoparticle powder was obtained.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

U.S. Pat. No. 6,906,339 and PCT published application WO 2005/013337 are incorporated herein in their entirety by reference.

What is claimed is:

1. A method of making nanoparticles, comprising:
reacting a first material powder with a second material vapor to form a surface coating on particles of the first material powder; and
selectively removing the first material powder to convert the surface coating to third material nanoparticles.

2. The method of claim 1, wherein the surface coating comprises a shell having a thickness less than about four Exciton Bohr Radii of the third material or a plurality of nanoparticles.

3. The method of claim 1, wherein:
the first material powder comprises a powder containing at least one element from Groups Ib to VIIb or Groups Ia to IVa and a different second element from Groups IVa to VIIa of the Periodic Table; and
the second material vapor comprises at least one element from groups VIa or VIIa of the Periodic Table.

4. The method of claim 3, wherein the first material powder comprises a metal oxide, nitride or sulfide powder.

5. The method of claim 3, wherein:
the first material powder comprises a metal oxide, nitride or sulfide powder selected from Zn, Pb, Cd, Al, Ga and In oxides and nitrides;
the second material vapor comprises at least one of N, P, As, Sb, S, Se and Te; and
the third material nanoparticles comprise III-V, II-VI or Pb-VI compound semiconductor nanoparticles.

6. The method of claim 1, wherein the step of reacting the first material powder with the second material vapor comprises providing the first material powder and a second material powder and heating at least the second material powder to generate the second material vapor.

7. The method of claim 6, wherein the step of reacting the first material powder with the second material vapor comprises:
placing the first material powder in a first vessel;
placing the second material powder in a second vessel; and
heating the first and second vessels to generate the second material vapor in the second vessel which is provided to the first vessel.

8. The method of claim 7, wherein the first and second vessels comprise sealed retorts which are connected to each other by a channel.

9. The method of claim 7, wherein the first material powder comprises ZnO or ZnS powder and the second material powder comprises at least one of S, Se or Te powders.

10. The method of claim 9, wherein the third material nanoparticles comprise red emitting ZnTe or ZnSTe nanoparticles, orange emitting ZnSe nanoparticles, yellow emitting ZnSSeTe nanoparticles, green emitting ZnSSe, ZnTeSe, ZnSTe or ZnSSeTe nanoparticles, or blue emitting ZnSSe nanoparticles.

11. The method of claim 7, wherein the step of heating comprises heating the first and the second vessels at a same time to different temperatures from each other.

12. The method of claim 7, wherein the first vessel is heated to a different temperature than the second vessel.

13. The method of claim 7, wherein the first vessel is heated to a same temperature as the second vessel.

14. The method of claim 1, wherein the step of selectively removing comprises a step of selectively etching the first material powder.

15. The method of claim 1, further comprising etching the third material nanoparticles to at least one of reduce the nanoparticle size or to reduce a size of nanoparticle clusters.

16. The method of claim 1, further comprising grinding the third material nanoparticles to reduce a size of nanoparticle clusters.

17. The method of claim 1, further comprising controlling ratios of the first and the second materials to control a composition of the third material.

18. The method of claim 17, wherein controlling the composition of the third material controls a luminescence color of the third material nanoparticles.

19. The method of claim 1, wherein the third material nanoparticles comprise luminescent semiconductor material nanoparticles whose peak luminescence wavelength is determined by a composition of the semiconductor material.

20. The method of claim 19, wherein the nanoparticles are not doped with activator ions.
